(19) United States
(12) Patent Application Publication
(10) Pub. No.: US 2009/0087006 A1
(43) Pub. Date: Apr. 2, 2009

(54) Sound tube for a hearing device

(75) Inventor: Chee Wah Leong, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/284,598

(22) Filed: Sep. 23, 2008

(30) Foreign Application Priority Data
Sep. 26, 2007 (DE) 10 2007 046 052.1

(51) Int. Cl. H04R 25/00

(52) U.S. Cl. 381/324; 381/330; 381/328

(57) ABSTRACT

A sound tube is provided for the transmission of sound from a hearing device that can be worn on the ear to the auditory canal of the user with a first tube piece, to whose first end an adapter is secured for connection to the hearing device, and a second tube piece formed in two parts with the first tube piece. A connecting piece serves to connect the two tube pieces. It ensures that the first tube piece can be rotated or pivoted in relation to the second tube piece. In a further embodiment one of the two tube pieces can pushed to a differing degree into or onto the connecting piece. The sound tube can therefore be used for ears of different sizes as well as for the left and right sides.

### CROSS REFERENCE TO RELATED APPLICATIONS

This application claims priority of German application No. 10 2007 046 052.1 DE filed Sep. 26, 2007, which is incorporated by reference herein in its entirety.

### FIELD OF INVENTION

The present invention relates to a sound tube for the transmission of sound from a hearing device that can be worn on the ear to the auditory canal of the user with a tube piece, to whose one end an adapter is secured for connection to the hearing device. The term “hearing device” here refers in particular to a hearing aid and also any other sound-emitting device that can be worn on the ear, such as headphones, a headset, etc. The present invention is therefore also specifically aimed at a hearing aid with an above-mentioned sound tube.

### BACKGROUND OF INVENTION

Hearing aids are hearing devices that can be worn and which are used to assist those with impaired hearing. Different types of hearing aids, such as behind-the-ear (BTE) hearing aids, hearing aids with an external receiver (RIC: receiver in the canal) and in-the-ear (ITE) hearing aids, e.g. also concha hearing aids or completely in the canal hearing aids (ITE, CIC), are available to meet the numerous individual needs. The hearing aids listed by way of example are worn on the outside of the ear or in the auditory canal. Bone conduction hearing aids and implantable or vibrotactile hearing aids are also commercially available. With these the impaired hearing is stimulated either mechanically or electrically.

The essential components of a hearing aid are in principle an input transducer, an amplifier and an output transducer. The input transducer is generally a sound receiver, e.g. a microphone, and/or an electromagnetic receiver, e.g. an induction coil. The output transducer is generally in the form of an electroacoustic transducer, e.g. a miniature loudspeaker, or an electromechanical transducer, e.g. a bone conduction receiver. The amplifier is generally incorporated in a signal processing unit. This basic structure is shown in FIG. 1 using the example of a behind-the-ear hearing aid. One or more microphones 2 for receiving ambient sound are incorporated in a hearing aid housing 1 to be worn behind the ear. A signal processing unit 3, which is likewise incorporated in the hearing aid housing 1, processes and amplifies the microphone signals. The output signal of the signal processing unit 3 is transmitted to a loudspeaker or receiver 4, which outputs an acoustic signal. In some instances the sound is transmitted by way of a sound tube, which is fixed in the auditory canal with an otoplastic, to the eardrum of the hearing aid wearer. Power is supplied to the hearing aid and in particular to the signal processing unit 3 by way of a battery 5 likewise incorporated in the hearing aid housing 1.

### SUMMARY OF INVENTION

In the case of hearing devices worn behind or on the ear, e.g. BTE hearing aids, the sound is conducted to the ear with the aid of a sound tube. It is desirable here for the sound tube to be embodied so that it is as optically discreet as possible. The aim is therefore to keep said sound tube as short as possible and also to keep it as close to the ear as possible. To this end the sound tubes of expensive hearing aids are molded individually. With low-cost aids the aim is to be able to meet individual needs as far as possible with the fewest possible standard molds. Therefore at present at least three different lengths of flexible sound tube are provided for low-cost aids, serving at the same time as a support hook for the hearing aid. Since these sound tubes are premolded, they have to be provided respectively as a left and right variant for a hearing aid to be worn on the left and a hearing aid to be worn on the right. This means that at least six sound tube variants have to be provided. This in turn requires six different production molds and six different part numbers. This means an increase in storage and manufacturing costs for low-cost hearing aids.

Such a hearing aid is known for example from the printed patent specification U.S. Pat. No. 6,681,022 B1. Here a universal eartip is secured to a premolded sound tube of the hearing device that can be worn on the ear (telephone, radio or other communication facility). The sound tube serves as a support hook at the same time and has a number of curves. A correspondingly suitable sound tube therefore has to be selected, depending on whether it is worn on the left or right ear.

A similar sound tube is also known from the printed patent specification U.S. Pat. No. 6,009,183 A. There the sound tube is interchangeable for the hearing device to be worn on the left ear or the right ear.

A hearing aid system with a hearing aid and an otoplastic that can be worn in the ear is known from the publication DE 201 14 121 U1. A sound tube with a quick-release coupling serves to connect the hearing aid to the otoplastic in a detachable manner. The sound tube can be connected directly to the otoplastic and the quick-release coupling can be located between the free end of the sound tube and the upper end of the hearing aid. Alternatively the sound tube can also be divided into two tube segments, which can be connected to one another and separated from one another by way of the quick-release coupling.

The publication EP 1 853 088 A2 also discloses an ear mold, on which a tube piece is mounted. This tube piece is inserted into a further tube, which provides the connection to a hearing aid.

The printed patent specification EP 0 997 057 B1 also discloses a behind-the-ear hearing aid system, wherein a tube of a hearing aid can be inserted into an eartip. The sound tube is more rigid than with conventional hearing aids and can be provided with annular barbs at its end, so that it can be inserted securely into the eartip.

The object of the present invention is to provide a sound tube for a hearing device, which on the one hand fits close to the respective ear and on the other hand has low storage and manufacturing costs.

According to the invention this object is achieved by a sound tube for the transmission of sound from a hearing device that can be worn on the ear to the auditory canal of the user, with a first tube piece, to whose first end an adapter is secured for connection to the hearing device, also comprising a second tube piece formed in two parts with the first tube piece and a connecting piece, to which on the one hand the second end of the first tube piece and on the other hand one end of the second tube piece are secured, the connecting piece ensuring that the first tube piece can be rotated or pivoted in relation to the second tube piece.

It is thus advantageously possible to use the sound tube both for a hearing device that can be worn on the left ear and a hearing device that can be worn on the right ear. Because the sound tube is in a number of parts and can be rotated within itself, it can also be used in a flexible manner. The number of variants of sound tubes that have to be provided can therefore be reduced, which ultimately means a reduction in storage and manufacturing costs for the hearing devices.

An adapter for an eartip is preferably attached to the free end of the second tube piece. This eartip can be an earmold or a universal eartip for example, which fixes the sound tube in the auditory canal.

The second tube piece can have a prefabricated curve in one spatial direction. In particular it is favorable, if the ends of the second tube piece are at an angle of 70 to 90°, in particular 80 or 79°. This takes best account of the average profile of the auditory canal.

According to one specific embodiment the connecting piece can be tubular and the two tube pieces can be rotated in relation to one another about the longitudinal axis of the connecting piece. It is thus possible for example for the one tube piece to be inserted into the first side of the connecting piece and the other tube piece to be pushed into or onto the second side of the connecting piece. The rotational symmetry of the connecting piece means that rotational support is also easy to realize here too.

As already indicated, one of the two tube pieces can be pushed onto the connecting piece. It is advantageous in particular if the insertion depth is variable. This means that a further dimension of the sound tube is variable.

The connecting piece can also have a number of barbs running in a peripheral direction one behind the other in an axial direction, onto which one of the two tube pieces is pushed in a rotatable manner. The barbs increase friction in an axial direction but allow rotational movement because they run in a peripheral direction.

It is also particularly advantageous if the first and/or second tube piece is flexible. This achieves the formability required to mold the sound tube more easily to individual requirements.

It is particularly preferable if the sound tube described above is secured with its adapter to a hearing aid, specifically a BTE hearing aid. This also reduces the overall manufacturing costs for hearing aids due to the reduced tube costs.

### BRIEF DESCRIPTION OF THE DRAWINGS

The present invention is described in more detail with reference to the accompanying drawings, in which:

FIG. 1 shows the basic structure of a hearing aid according to the prior art;

FIG. 2 shows a sound tube according to the prior art and

FIG. 3 shows an inventive sound tube.

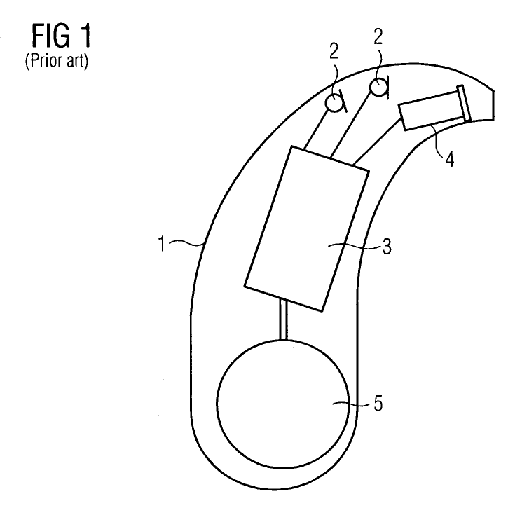

### DETAILED DESCRIPTION OF INVENTION

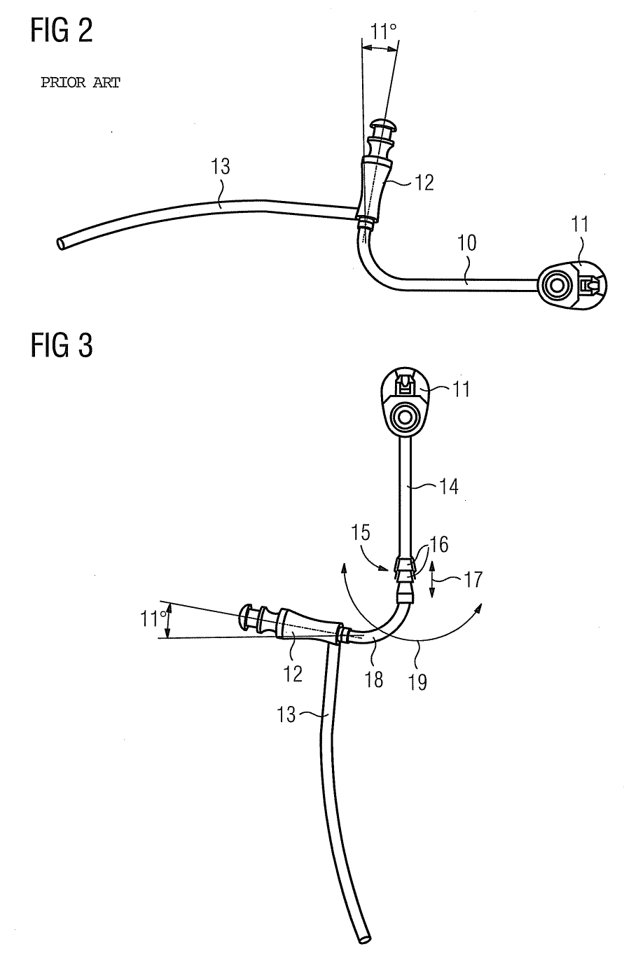

The exemplary embodiments described in more detail below represent preferred embodiments of the present invention. However it is first necessary to describe a sound tube from the prior art in more detail with reference to FIG. 2 for a better understanding of the invention.

The sound tube illustrated in FIG. 2 has a tube piece 10, to whose first end an adapter 11 is secured for connection to a hearing aid. This adapter 11 therefore serves not only to hold the sound tube on the hearing aid but also to inject the sound from the receiver of the hearing aid into the tube piece 10. An eartip adapter 12 is secured to the second end of the tube piece 10. It serves to secure an interchangeable universal eartip (not shown). A longish holding element 13 is molded onto the eartip adapter 12 perpendicular to its longitudinal extension, said eartip adapter 12 itself being roughly tubular. This holding element 13 is flexible and can be positioned in the recesses of the outer ear, so that the eartip adapter 12 or tube piece 10 is fixed more securely in the auditory canal. The tube piece 10 also has a, prefabricated curve. The ends of the tube piece 10, i.e. the axial profiles at the ends, are at an angle of 79° to one another. This means that the sound tube can generally be inserted coaxially into the auditory canal. The length and curvature of the tube piece are however predefined. This means that the sound tube as a whole can only be used for specific ear size, in this instance on the right ear.

According to the invention a universal sound tube is provided, which can be used both on the left ear and on the right ear and for different ear sizes. According to the exemplary embodiment in FIG. 3 the sound tube has a first tube piece 14, to whose first end the hearing aid adapter 11 is secured. The second end of the first tube piece 14 is pushed onto a connecting piece 15. This connecting piece 15 is tubular and has a number of barbs 16 in its axial direction, which for their part run in a peripheral direction.

The first tube piece 14 can be pushed or inserted as far as necessary by way of the connecting piece 15. This means that a certain length 17 of the first tube piece 14 is variable in an axial direction of the connecting piece 15.

A second tube piece 18 is inserted, molded, adhered or otherwise secured in the end of the connecting piece 15 facing away from the first tube piece 14. The eartip adapter 12 with its holding element 13 is secured to the other end of the second tube piece 18. The second tube piece 18 is flexible like the first tube piece 14. However, as in the example in FIG. 2, the second tube piece 18 is premolded in such a manner that its ends are at an angle of 79°. This angle is preferably between 70° and 90°, so that the eartip adapter 12 projects into the auditory canal as coaxially as possible.

As the connecting piece 15 has rotational symmetry and in particular as the barbs 16 run in a peripheral direction, the second tube piece 18 can be rotated about the longitudinal axis 18 of the connecting piece 15, in other words in relation to the first tube piece 14, as shown by the double arrow 19. This means that the sound tube as a whole can be used both for a left and for a right hearing aid. In particular it can also be used as a left support hook and a right support hook for lower-cost hearing aids. Its length is also variable, so it can also be used for different ear sizes.

Generally then the sound tube according to the exemplary embodiment in FIG. 3 can be used in a wide range of situations, with the result that the manufacturing process for sound tubes can not only be simplified but overall manufacturing costs for hearing aids can also be reduced.

1.-7. (canceled)

8. A sound tube for the transmission of sound from a hearing device is worn on the ear to the auditory canal of a user, comprising:
a first tube piece having a first end and a second end, the first end secured to an adapter for connecting to the hearing device;
a second tube piece having a first end and a second end; and
a one-part connecting piece to which the second end of the first tube piece and first end of the second tube piece are secured, the connecting piece ensures that the first tube piece is rotatable in relation to the second tube piece,
wherein the second tube piece has a prefabricated curve in one spatial direction, and one of the two tube pieces is pushed onto the connecting piece to a variable insertion depth.

9. The sound tube as claimed in claim 8, wherein an adapter for an eartip is attached to the second end of the second tube piece.

10. The sound tube as claimed in claim 9, wherein the ends of the second tube piece are at an angle of 70 to 90.

11. The sound tube as claimed in claim 8, wherein the connecting piece is tubular and the first and second tube pieces are rotatable in relation to one another about the longitudinal axis of the connecting piece via the connecting piece.

12. The sound tube as claimed in claim 8, wherein the connecting piece includes a plurality of barbs in a peripheral direction one behind the other in an axial direction, onto which one of the two tube pieces is pushed in a rotatable manner.

13. The sound tube as claimed in claim 8, wherein first and second tube pieces are flexible.

14. The sound tube as claimed in claim 8, wherein first or second tube pieces is flexible.

15. A sound tube for the transmission of sound from a hearing device is worn on the ear to the auditory canal of a user, comprising:
a first tube piece having a first end and a second end, the first end secured to an adapter for connecting to the hearing device;
a second tube piece having a first end and a second end, the second tube piece has a prefabricated curve in one spatial direction; and
a connecting piece to which the second end of the first tube piece and first end of the second tube piece are secured such that at least one of the connecting end pieces is pushed onto the connecting piece to a variable insertion depth in order to change the length of the sound tube,
wherein the connecting piece ensures that the first tube piece is rotatable in relation to the second tube piece, and
wherein the connecting piece includes a plurality of barbs.

16. A hearing aid system, comprising:
a hearing aid a support hook; and
a sound tube, comprising:
an adapter connected to the hearing aid,
a first tube piece having a first end and a second end, the first end secured to an adapter for connecting to the hearing device,
a second tube piece having a first end and a second end, the second tube piece has a prefabricated curve in one spatial direction, and
a one-part connecting piece to which the second end of the first tube piece and first end of the second tube piece are secured, the connecting piece ensures that the first tube piece is rotatable in relation to the second tube piece, one of the two tube pieces is pushed onto the connecting piece to a variable insertion depth.

17. The hearing aid system as claimed in claim 16, wherein an adapter for an eartip is attached to the second end of the second tube piece.

18. The hearing aid system as claimed in claim 16, wherein the ends of the second tube piece are at an angle of 70 to 90.

19. The hearing aid system as claimed in claim 16, wherein the connecting piece is tubular and the first and second tube pieces are rotatable in relation to one another about the longitudinal axis of the connecting piece via the connecting piece.

20. The hearing aid system as claimed in claim 16, wherein the connecting piece includes a plurality of barbs in a peripheral direction one behind the other in an axial direction, onto which one of the two tube pieces is pushed in a rotatable manner.

21. The hearing aid system as claimed in claim 16, wherein first and second tube pieces are flexible.

22. The hearing aid system as claimed in claim 16, wherein first or second tube pieces is flexible.
